(19) United States
(12) Patent Application Publication
(10) Pub. No.: US 2005/0139061 A1
(43) Pub. Date: Jun. 30, 2005

(54) Stackable actuator housing

(75) Inventors: Jared Timko, Mentor, OH (US); Gary Scheffel, Streetsboro, OH (US)

Correspondence Address: CALFEE HALTER & GRISWOLD, LLP, 800 SUPERIOR AVENUE, SUITE 1400, CLEVELAND, OH, 44114, US

(73) Assignee: Swagelok Company

(21) Appl. No.: 11/023,313

(22) Filed: Dec. 27, 2004

Related U.S. Application Data
(60) Provisional application No. 60/481,836, filed on Dec. 29, 2003.

(51) Int. Cl. F15B 11/18

(52) U.S. Cl. 91/167 R

(57) ABSTRACT

An actuator housing assembly with modular components that have a commonality in construction to allow the actuator to include multiple pistons by stacking the modular components. The actuator may include a housing construction that permits optimization of the piston surface area in multiple piston operation.

### RELATED APPLICATION

The present application claims priority from U.S. provisional application Ser. No. 60/481,836, entitled “Stackable Actuator,” filed on Dec. 29, 2003 the entire disclosure of which is fully incorporated herein by reference.

### FIELD OF THE INVENTION

The present invention relates to fluid actuators, such as pneumatic actuators. In particular, the invention relates to fluid actuators with modular stackable housings.

### BACKGROUND OF THE INVENTION

Valves frequently employ fluid actuators, such as pneumatic actuators to regulate flow through the valve. A pneumatic actuator typically uses air pressure to open and/or close the valve, thereby controlling the flow of fluid within and through the valve. Actuators may utilize multiple pistons to increase force output. Multiple pistons allow for additional surface area for inlet pressure to act upon, thereby increasing the load output. One constraint operating on an actuator is its overall base size or footprint. In operation, footprint space is frequently limited. As such, it is desirable to provide an actuator that could produce more output force for an actuator of a given footprint or outer diameter size.

FIG. 1 illustrates a known multi-piston actuator and valve assembly, generally comprising a valve assembly 10 and a multi-piston actuator 20. The valve 10 can be any number of configurations, and is generally shown as a diaphragm valve with one input port and one outlet port.

The prior art actuator 20 shown in FIGS. 1 and 3 includes an actuator housing 25, two dynamic pistons 30 and 32 and one static piston 35. The static piston 35 is located between the upper dynamic piston 32 and the lower dynamic piston 30. The static piston 35 provides a surface that allows pressure to build between the static piston and the upper dynamic piston 32. As shown, the dynamic pistons 30 and 32 are loaded in the downward direction, towards the valve body 10, by the force applied by spring 40. Actuation air enters the actuator assembly 20 through input 42 and through channel 44 in the stem 45 of the upper dynamic piston 32 and into the upper actuation volume 46 and acts on upper piston surface area 47. The air also continues through channel 48 in the stem 49 of the lower dynamic piston 30 and into the lower actuation volume 50 and acts on lower piston surface area 51. As shown in FIG. 3, as the pressure acts on the upper and lower actuation areas 47 and 51, force, as shown by force lines 55, act on the dynamic pistons 30 and 32 to drive the pistons against the force of the spring 40.

As best shown in FIG. 3, the actuator housing 25 includes an interior wall 59 with a stepped portion 60 that provides a positive stop for the static piston 35. The stepped portion 60 ensures that the static piston 35 cannot move downward once air fills the upper actuation volume 46 and thereby provides a static surface against which the air can build pressure and act upon the surface 47 of the upper dynamic piston 32. The stepped portion 60 results in a decrease in the diameter D1 of the lower dynamic piston 30 as compared to the diameter D2 of the upper dynamic piston. As such, the smaller piston diameter D1 provides for less actuation surface area, and thus less load or output force that can be produced by the piston having diameter D2.

A two-piston actuator 20 as shown in FIG. 3 includes six seals: an upper piston stem seal 63, a upper dynamic piston seal 64, a static seal 65, a lower dynamic piston stem seal 66, a lower dynamic piston seal 67, and a reduced-area actuator seal 68. These seals prevent actuator air pressure from leaking into undesired areas, which would adversely effect the efficiency of the actuator.

### SUMMARY

The present invention contemplates an actuator housing assembly with modular components that have a commonality in construction to allow the actuator to include multiple pistons by stacking the modular components. The actuator may include a housing construction that permits optimization of the piston surface area in multiple piston operation.

One aspect of the present invention is a fluid actuator, such as a pneumatic actuator housing assembly that includes first and second interchangeable or modular piston housings. The first and second interchangeable piston housings are assembled to define at least portions of first and second piston compartments. For example, the second interchangeable piston housing may define an upper portion of the first piston compartment and a lower portion of the second piston compartment. In one embodiment, a piston compartment is added to the actuator housing assembly by each interchangeable piston housing that is included.

In one embodiment, the interchangeable piston housing is assembled with an interchangeable or modular piston to form a housing and piston assembly. The force that can be provided by the actuator can be increased or decreased by increasing or decreasing the number of modular housing and piston assemblies included in the actuator. In embodiments where one or more springs are used to bias the pistons to a normal position, the force applied by the spring or springs may be adjusted based on the force that can be provided by the pistons. For example, a spring may be added or removed or a spring may be replaced with a spring that has a higher or lower spring constant. The number of interchangeable piston and housing assemblies may be selected and/or adjusted based on the desired output force.

One aspect of the present invention relates to a fluid actuator housing assembly. The housing assembly includes a first piston housing, a second piston housing, and a cap. The second piston housing is assembled with the first piston housing such that the first piston housing and the second piston housing define a first piston compartment. The cap is assembled with the second piston housing, such that the second piston and the cap define a second piston compartment.

In one embodiment, additional piston housings can be added to define additional piston compartments. The additional piston housing(s) may be interchangeable with the second piston housing.

In one embodiment, the second piston housing defines a stop of the first piston compartment. In one embodiment, a diameter of the first piston compartment may be equal or even greater than a diameter of the second piston compartment.

One aspect of the present invention relates to a fluid actuator. The fluid actuator includes a housing assembly, a first piston, and a second piston. The housing assembly includes a first piston housing, a second piston housing, and a cap. The second piston housing is assembled with the first piston housing such that the first piston housing and the second piston housing define a first piston compartment. The cap is assembled with the second piston housing, such that the second piston and the cap define a second piston compartment. The housing assembly defines an inlet. The first piston is disposed in the first piston compartment and the second piston is disposed in the second piston compartment. Application of fluid under pressure to the input moves the first piston to a first piston actuated position and moves the second piston to a second piston actuated position.

In one embodiment, a biasing member is disposed in the housing assembly. The biasing member biases the first piston to a first piston normal position and biases the second piston to a second piston normal position. The first piston may include a force application member or stem that extends through the first piston housing. A force transfer member may extend through the second piston housing. The force transfer member couples the first and second pistons.

In one embodiment, additional piston(s) and piston housing(s) can be added. The additional piston(s) and housing(s) may be interchangeable with the second piston and the second piston housing.

One aspect of the present invention relates to a method of assembling a fluid actuator. A first piston is positioned in a first piston housing. A second piston housing is assembled with the first piston housing such that the second piston housing limits movement of the first piston. A second piston is positioned in a second piston housing. A cap is assembled with the second piston housing such that the cap limits movement of the second piston. In one embodiment, additional piston(s) and piston housing(s) may be added between the second piston housing and the cap.

One aspect of the present invention is a fluid control system that includes a fluid actuator and a fluid control device, such as a valve. The fluid actuator comprises interchangeable piston and housing assemblies. The fluid control device is operated by the actuator.

Further advantages and benefits will become apparent to those skilled in the art after considering the following description and appended claims in conjunction with the accompanying drawings.

### BRIEF DESCRIPTION OF THE DRAWINGS

FIG. 1 is a cross-sectional view of a valve body and prior art multi-piston actuator assembly of the prior art;

FIG. 2 is a cross-sectional view of a valve and stackable actuator assembly of the present invention;

FIG. 3 is a cross-sectional view of the prior art multi-piston actuator assembly of FIG. 1, further illustrating the forces acting upon each of the pistons of the actuator assembly;

FIG. 4 is a cross-sectional view of the stackable actuator assembly of FIG. 2, further illustrating the forces acting upon each of the pistons of the actuator assembly;

FIG. 5A is a cross-sectional view of a stackable actuator that includes two pistons;

FIG. 5B is a cross-sectional view of a stackable actuator that includes three pistons;

FIG. 5C is a cross-sectional view of a stackable actuator that includes four pistons; and

FIG. 6 illustrates a stackable actuator assembly with a housing assembly that includes components connected by a detent-type connection.

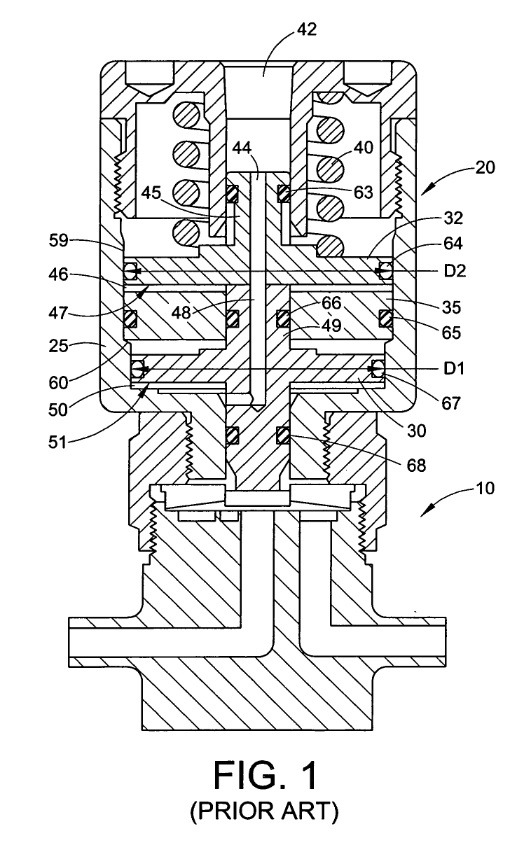

### DETAILED DESCRIPTION

The present invention contemplates an actuator housing assembly 70 with modular components that have a commonality in construction to allow the actuator to include multiple pistons by stacking the modular components. The actuator includes a housing construction that permits optimization of the piston surface area in multiple piston operation. Such optimization may be achieved without stackable components. The exemplary actuator also provides for a reduction in seal points.

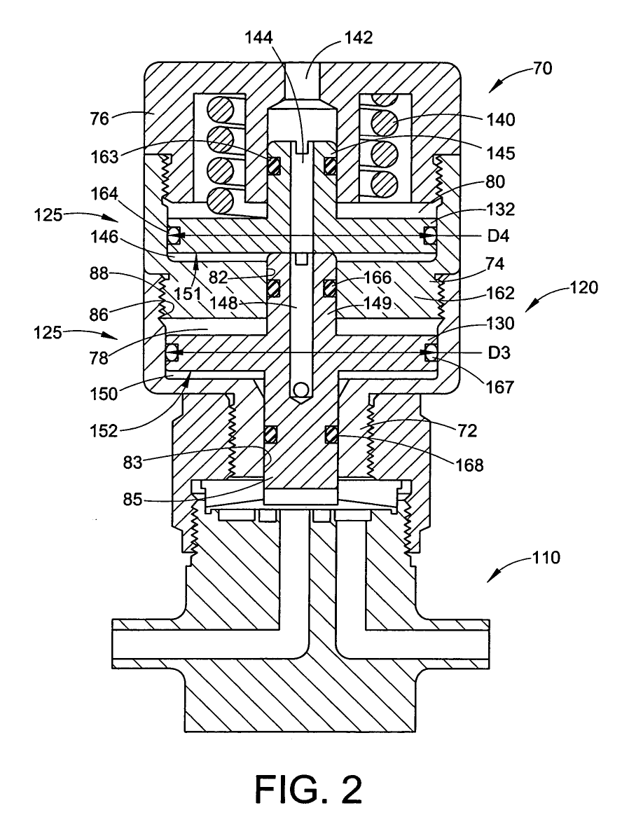

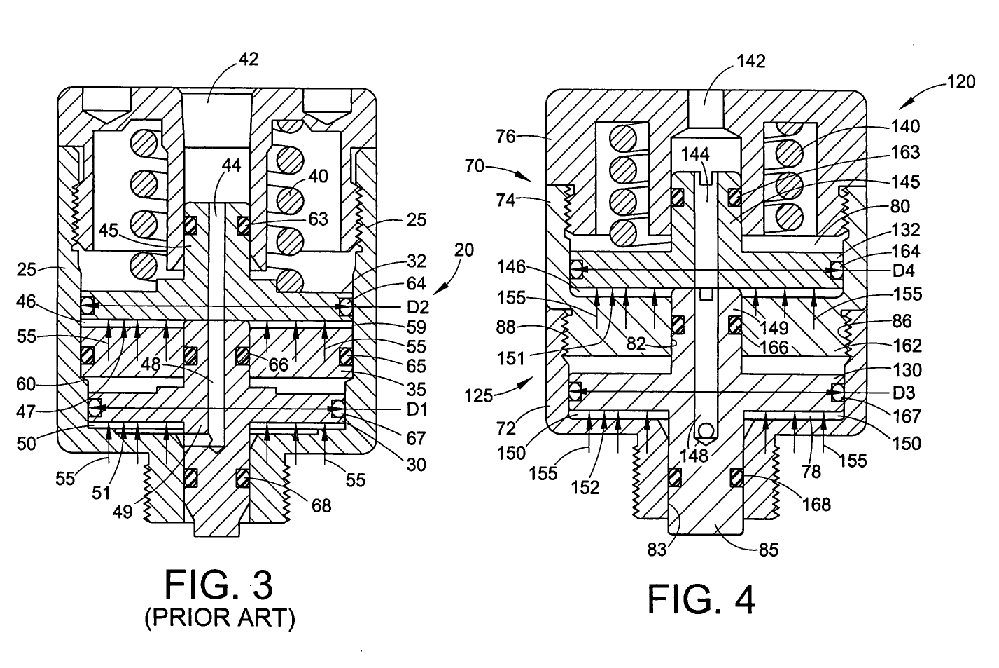

FIGS. 2 and 4 illustrate a housing assembly 70 for a fluid actuator 120, which in the illustrated embodiment is a pneumatic actuator. It should be readily apparent that the present invention could be applied in other types of fluid actuators, such as hydraulic actuators. The housing assembly 70 includes a first piston housing 72, a second piston housing 74, and a cap 76. The second piston housing 74 is assembled with the first piston housing 72, such that the first piston housing 72 and the second piston housing 74 define a first piston compartment 78. The cap 76 is assembled with the second piston housing 74, such that the second piston housing and the cap 76 define a second piston compartment 80. The housing assembly components can be made from a wide variety of materials. Examples of acceptable materials include brass, aluminum, steel, stainless steel, plastic, cast material, and sintered material.

The pneumatic actuator 120 includes the housing assembly 70, a first piston 130, and a second piston 132. The first piston 130 is disposed in the first piston compartment 78 and the second piston 132 is disposed in the second piston compartment 80. The pistons can be made from a wide variety of materials. Examples of acceptable materials include brass, aluminum, steel, stainless steel, plastic, cast material, and sintered material.

FIGS. 2 and 4 illustrate one example of an actuator 120 that includes a housing assembly 70 with stackable components. Generally the actuator housing assembly 70 needs not include stackable components to include other aspects of the invention. Furthermore, the actuator is illustrated as acting on a fluid control device, such as a valve assembly 110; however the actuator can be used in conjunction with any mechanism that employs an actuator with a short stroke and provides a relatively high load. The valve assembly 110 can be any number of configurations, and is generally shown as a diaphragm valve with one input port and one outlet port. One skilled in the art would appreciate that the present invention can be applied to a variety of valve bodies that are actuated by a piston actuator, and are included within the scope of this application.

The stackable actuator 120 shown in FIGS. 2 and 4 includes a multi-sectional and expandable housing assembly 70 and two dynamic pistons 130 and 132. In the orientation illustrated by the example of FIGS. 2 and 4, the first piston housing 72 is a lower piston housing and the second piston housing 74 is an upper piston housing. Portions of the upper piston housing 74 and the lower piston housing 72 serve as the actuator outer housing 125. The upper dynamic piston housing 74 is located between the upper dynamic piston 132 and the lower dynamic piston 130. The upper dynamic piston housing isolates the lower piston compartment from the upper piston compartment and provides a surface that allows pressure to build between the upper dynamic piston housing and the upper dynamic piston. In the example illustrated by FIGS. 2 and 4, the dynamic pistons 130 and 132 are loaded in the illustrated downward direction, towards the valve body 110, by force applied by a biasing member 140, such as a spring or other spring-like member. the spring can be made from a wide variety of different materials. For example, the spring may be made from stainless steel, 302, steel, 17/7 steel, or plastic. Air enters the actuator assembly 120 through input 142 and through channel 144 in the stem 145 of the upper dynamic piston 132 and into the upper actuation area 146. The upper piston housing 74 defines a force transfer passage 82 that extends between the first piston compartment 78 and the second piston compartment 80. A force transfer member 149 extends through the passage 82 and couples the first and second pistons. In the illustrated embodiment, the force transfer member 149 is a stem of the lower dynamic piston 130. The air continues through channel 148 in the stem 149 of the lower dynamic piston 130 and into the lower actuation area 150. As shown in FIG. 4, as the air enters the upper and lower actuation volumes 146 and 150 and pressure acts on surface areas 151 and 152, force, as shown by force lines 155, act on the dynamic pistons 130 and 132 to drive the pistons against the force of the spring 140 to actuated positions. In the illustrated embodiment, the lower piston housing 72 defines a force transfer passage 83. The first piston 72 includes a force application member 85 that extends through the passage. The force application member moves in the passage between the normal and actuated positions.

In the embodiment illustrated by FIGS. 2 and 4, the stackable actuator 120 is formed of three sections, the lower piston housing 72, the upper piston housing 74 and the end cap 76. In the illustrated embodiment, the lower piston housing 74 threads into the valve body. The stackable actuator assembly 120 provides for threadable engagement of the upper piston housing 74 to the lower piston housing 72 and for threadable engagement of the end cap 76 to the upper piston housing 74. In the example of FIGS. 2 and 4, the lower piston housing 72 includes a first threaded region 86 and the upper piston housing 88 includes a second threaded region. The upper piston housing is assembled with the lower piston housing by engagement of the first threaded region 86 with the second threaded region 88.

The threadable engagement of the upper piston housing 74 eliminates the need for the stepped area 60 in the prior art multi-piston actuator 20. The threads positively retain the upper piston housing 74 in place. The portion 162 of the upper piston housing that defines the threads provides a surface which allows force to act against the upper dynamic piston 132. Since the upper piston housing 74 is retained by the threaded regions 86, 88, and thus does not require a stepped region, the diameter of the lower piston D3 can be equal to the diameter of the upper piston D4. In one embodiment, the diameter of the lower piston D3 can be even larger than the diameter of the upper piston. Since the piston diameters are the same, or the lower piston has a larger diameter, the stackable actuator 120 has an increased piston surface area as compared to a prior art multi-piston actuator 20 having the same overall diameter and can thereby provide an increased force. The stackable actuator 120 can increase the piston area by approximately 10-20 percent over a multi-piston actuator having the same overall diameter. For example, a multi-piston actuator 20 which includes a lower piston having a diameter of 1.1955 inches would be equivalent in overall actuator diameter to a stackable actuator 120 with a lower piston having a 1.2595 inch diameter. As such, the piston area of the lower piston would increase by approximately 11.75 percent.

In the illustrated embodiment, one seal is eliminated, as compared to the prior art multi-piston actuator 20. The example of a stackable actuator shown in FIGS. 2 and 4 includes five seals: an upper piston stem seal 163, a upper dynamic piston seal 164, a lower dynamic piston stem seal 166, a lower dynamic piston seal 167, and a reduced-area actuator seal 168. The reduction in the number of required seals increases the overall integrity of the actuator assembly.

It should be appreciated by one skilled in the art that, while the stackable actuators are shown as normally extended actuators, the biasing members and inlets can be configured such as to provide a normally retracted stackable actuator. A normally retracted stackable actuator incorporating the features described herein is contemplated and included in this application. It should also be appreciated by one skilled in the art that the biasing member could be omitted. In this embodiment, gravity, some other external force, could bias the actuator to the normal position. In one embodiment, the actuator is a double-acting actuator where fluid pressure is selectively applied to the first inlet and to a second inlet to move the actuator to a variety of positions between first and second end positions.

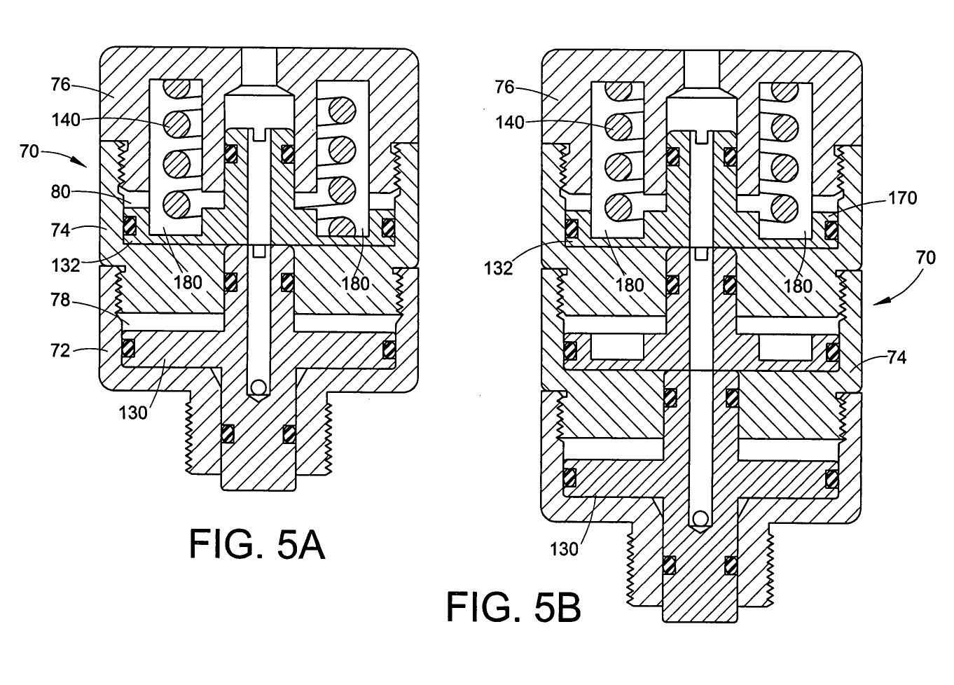

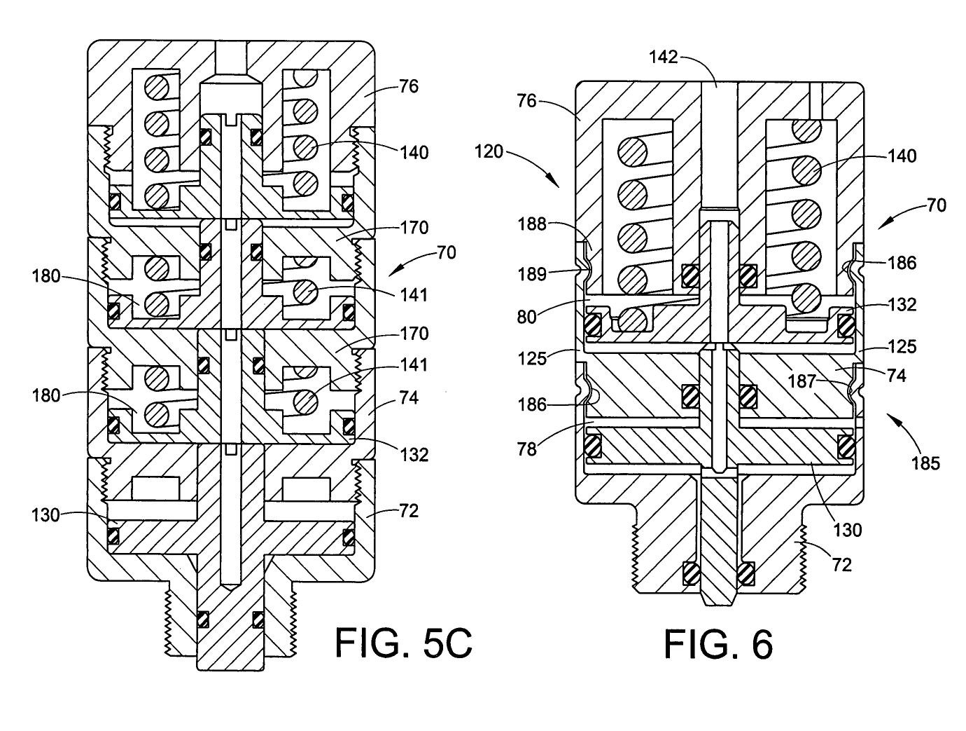

In one embodiment, one or more additional pistons and piston housings can be selectively added. For example, the additional one or more pistons and housings may be interchangeable with the upper piston 132 and the upper piston housing 74. In the example of FIGS. 5B and 5C, the additional pistons and housings are substantially identical to the upper piston 132 and housing 74. In the example of FIGS. 5B and 5C, each modular or interchangeable piston housing 74 defines a portion of two piston compartments. For example, the interchangeable piston housings illustrated in FIGS. 5B and 5C each define the upper portion of the piston compartment below the interchangeable piston housing and the lower portion of the piston housing above the interchangeable piston housing. The addition of one interchangeable piston housing adds one piston compartment. An advantage of the stackable actuator housing assembly 70 is that the number of pistons can be easily changed, by adding or removing piston and housing assemblies. In the embodiments illustrated by FIGS. 5A-5C, one or more of the pistons can include a spring cut-out area 180. This cut-out area 180 accommodates a portion of the spring 140 thereby providing for additional space for the spring 140. FIG. 5C illustrates that additional springs 141 can be added in the piston compartments to change the biasing force. The biasing force can also be changed by replacing the spring 140 with a different spring that has a different spring constant.

FIGS. 5A-5C illustrate a two-piston actuator assembly, a three-piston actuator assembly and a four-piston actuator assembly respectively. The actuators are assembled by positioning the first piston 130 in the first piston housing 72. The second piston housing 74 is assembled with the first piston housing such that the second piston housing limits movement of the first piston 130. The second piston 132 is positioned in the second piston housing. Any additional piston actuator piston assemblies 170 (a piston housing 74 and a piston 132) are assembled to the second piston housing. In the illustrated embodiment, the piston assemblies 170 also include o-rings. In the example of FIG. 5C, the additional piston assemblies include a spring 141. For example, no additional piston assemblies are added in the example of FIG. 5A, one additional piston assembly is added in the example of FIG. 5B, and two additional piston assemblies are added in the example of FIG. 5C. Any number of additional piston assemblies 170 can be added. In the example of FIG. 5C, two additional springs 141 are added to increase the biasing force applied to the pistons. The forces applied by the springs to the pistons are additive. The number of interchangeable piston and housing assemblies may be selected and/or adjusted based on the desired output force of the actuator. The biasing member is applied to the last piston and the cap 76 is assembled with the modular housing assembly 70 to complete the assembly.

Additional pistons can be added to the stackable actuator as needed to increase the actuation force. As contrasted with the prior art multi-piston actuator 20, which would lose actuation surface area for each piston that was added, the stackable actuator would fully retain the actuation surface area for each piston that was added. As such, the stackable actuator 120 can provide for an increased load as compared to the prior art multi-piston actuator 20. In addition, if an increase in actuator load is desired, the stackable actuator 120 allows for the removal of the end cap 76, the addition of another actuator piston assembly 170, and the reapplication of the end cap onto the added actuator piston assembly. This changeover can be made due to the commonality of the structural components between the actuator modules. With the prior art multi-piston actuator 20, the entire actuator would have to be removed and replaced with another actuator assembly with an increased number of pistons.

FIG. 6 shows another embodiment of the stackable actuator 120, where each of the components of the actuator housing assembly are connected by a detent-type or snap-type connection. The detent-type connections reduce the wall thickness of the actuator outer housing 125 to provide increased actuator area for the pistons. In this embodiment, the threaded regions 86, 88 are replaced with a detent-type connection 185. The detent-type connection 185 can be, for example, a raised surface 186 on the inside wall of the actuator outer housing 125 that operates in conjunction with a recess 187 along the side wall of the upper piston housing 74. When the upper piston housing 74 is placed onto the lower piston housing 72, the upper piston housing 72 will displace the outer wall of the lower piston housing until the recess 187 aligns with the raised surface 186. Once aligned, the upper and lower piston housings will snap together. The end cap 76 can include a flange 188 with a recess 189 so that it can snap into place in a similar fashion. In other embodiments, the flange or actuator housing does not initially include a raised surface, but instead material from the flange or actuator housing is rolled into the recess 187 to create the detent-assembly. By employing this method of assembly, the raised surface does not need to be integrally molded and the pieces can be assembled loosely.

By using the detent-type connection 185 the area of the pistons used in the stackable actuator 120 can increase approximately 30-45 percent. For example, a threaded stackable actuator may include a piston with a diameter of 1.2595 inches, while a detent-assembly fixture having the same overall diameter would be able to accommodate a piston with a 1.375 inch diameter, thereby providing an increase in piston area of approximately 34.5 percent.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A fluid actuator housing assembly, comprising:
a) a first piston housing;
b) a second piston housing assembled with the first piston housing, wherein the first piston housing and the second piston housing define a first piston compartment; and
c) a cap assembled with the second piston housing, wherein the second piston housing and the cap define a second piston compartment.

2. The fluid actuator housing assembly of claim 1 wherein the second piston housing defines a stop of the first piston compartment.

3. The fluid actuator housing assembly of claim 1 wherein the first piston housing defines a force transfer passage that extends through the first piston housing to the first piston compartment.

4. The fluid actuator housing assembly of claim 1 wherein the second piston housing defines a force transfer passage that extends between the first piston compartment and the second piston compartment.

5. The fluid actuator housing assembly of claim 1 wherein the first piston housing includes a first threaded region and the second piston housing includes a second threaded region, and wherein the second piston housing is assembled with the first piston housing by engagement of the second threaded region with the first threaded region.

6. The fluid actuator housing assembly of claim 1 wherein a diameter of the first piston compartment is equal to a diameter of the second piston compartment.

7. The fluid actuator housing assembly of claim 1 wherein a connection between the first piston housing and the second piston housing comprises a raised surface that cooperates with a recess.

8. A fluid actuator housing assembly, comprising:
a) a first piston housing;
b) a second piston housing assembled with the first piston housing, wherein the first piston housing an the second piston housing define a first piston compartment;
c) a third piston housing assembled with the second piston housing, wherein the second piston housing and the third piston housing define a second piston compartment; and
d) a cap assembled with the third piston housing, wherein the third piston housing and the cap define a third piston compartment.

9. The fluid actuator housing assembly of claim 8 wherein the second piston housing and the third piston housing are interchangeable.

10. A fluid actuator, comprising:
a) a housing assembly comprising:
i) a first piston housing;
ii) a second piston housing assembled with the first piston housing, wherein the first piston housing and the second piston housing define a first piston compartment; and
iii) a cap assembled with the second piston housing, wherein the second piston housing and the cap define a second piston compartment and wherein the housing assembly defines an input;
b) a first piston disposed in the first piston compartment; and
c) a second piston disposed in the second piston compartment, wherein application of fluid under pressure to the input moves the first piston to a first piston actuated position and moves the second piston to a second piston actuated position.

11. The fluid actuator of claim 10 further comprising a biasing member disposed in the housing assembly that biases the first piston to a first piston normal position and biases the second piston to a second piston normal position.

12. The fluid actuator of claim 10 wherein the second piston housing defines a stop for the first piston.

13. The fluid actuator of claim 10 wherein the first piston includes a force application member that extends through the first piston housing.

14. The fluid actuator of claim 10 further comprising a force transfer member that extends through the second piston housing, wherein the force transfer member couples the first and second pistons.

15. The fluid actuator of claim 10 wherein a diameter of the first piston is equal to a diameter of the second piston.

16. A fluid actuator, comprising:
a) a housing assembly comprising:
i) a first piston housing;
ii) a second piston housing assembled with the first piston housing, wherein the first piston housing and the second piston housing define a first piston compartment;
iii) a third piston housing assembled with the second piston housing, wherein the second piston housing and the third piston housing define a second piston compartment; and
iii) a cap assembled with the third piston housing, wherein the third piston housing and the cap define a third piston compartment and wherein the housing assembly defines an input;
b) a first piston disposed in the first piston compartment; and
c) a second piston disposed in the second piston compartment; and
d) a third piston disposed in the third piston compartment, wherein application of fluid under pressure to the input moves the first piston to a first piston actuated position, moves the second piston to a second piston actuated position, and moves the third piston to a third piston actuated position.

17. The fluid actuator of claim 16 wherein the second piston housing and the third piston housing are interchangeable.

18. The fluid actuator of claim 16 wherein the second piston and the third piston are interchangeable.

19. A method of assembling a fluid actuator, comprising:
a) positioning a first piston in a first piston housing;
b) securing a second piston housing to the first piston housing such that the second piston housing limits movement of the first piston;
c) positioning a second piston in the second piston housing;
d) securing a cap to the second piston housing such that the cap limits movement of the second piston.

20. The method of claim 19 further comprising positioning a biasing member between the cap and the second piston to bias the second piston to a normal position.

21. The method of claim 19 further comprising positioning a third piston in a third housing and securing the third housing to the first housing such that the first housing limits movement of the third piston.

22. The method of claim 19 wherein a force application member of the first piston is inserted into a passage in the first piston housing.

23. The method of claim 19 wherein a force transfer member is placed in a passage through the second piston housing, wherein the force transfer member couples the first and second pistons.

24. A method of assembling a fluid actuator, comprising:
a) positioning a first piston in a first piston housing;
b) securing a second piston housing to the first piston housing such that the second piston housing limits movement of the first piston;
c) positioning a second piston in the second piston housing;
d) securing a third piston housing to the second piston housing such that the third piston housing limits movement of the first piston;
e) positioning a third piston in the third piston housing;
f) securing a cap to the third piston housing such that the cap limits movement of the third piston.

25. The method of claim 24 wherein the second piston housing and the third piston housing are interchangeable.

26. The method of claim 24 wherein the second piston and the third piston are interchangeable.

27. A fluid actuator housing assembly, comprising: first and second interchangeable piston housings assembled to define at least portions of first and second piston compartments.

28. The fluid actuator housing assembly of claim 27 wherein the second interchangeable piston housing defines an upper portion of the first piston compartment and a lower portion of the second piston compartment.

29. A fluid actuator, comprising:
a) a first piston and housing assembly;
b) a second piston and housing assembly assembled with the first piston and housing assembly, wherein the first piston and housing assembly is interchangeable with the second piston and housing assembly.

30. The fluid actuator of claim 29 wherein a force provided by the actuator is increased by adding one or more additional interchangeable piston and housing assemblies.

31. A fluid actuator housing assembly, comprising:
a) a first piston housing;
b) second and third interchangeable piston housings assembled with the first piston housing, wherein the first piston housing an the second piston housing define a first piston compartment, and the second piston housing and the third piston housing define a second piston compartment.

32. A fluid actuator housing assembly, comprising:
a) a first piston housing;
b) one or more interchangeable piston housings assembled with the first piston housing; wherein a piston compartment is added to the actuator housing assembly by each interchangeable piston housing that is included.

33. A method of configuring a fluid actuator to provide a desired output force, comprising:
a) determining a desired output force to be provided by the fluid actuator;
b) selecting a number of interchangeable piston and housing assemblies based on the desired output force;
c) assembling the selected number of interchangeable piston and housing assemblies together to construct the fluid actuator.

34. The method of claim 31 further comprising adjusting an output force provided by the fluid actuator by removing one or more piston and housing assemblies.

35. The method of claim 31 further comprising adjusting an output force provided by the fluid actuator by adding one or more piston and housing assemblies.

36. A fluid control system, comprising:
a) a fluid actuator comprising interchangeable piston and housing assemblies; and
b) a fluid control device that is operated by the actuator.

37. The fluid control device of claim 34 wherein the fluid control device is a valve.
